(19) United States
(12) Patent Application Publication
(10) Pub. No.: US 2024/0199163 A1
(43) Pub. Date: Jun. 20, 2024

(54) METHOD FOR PRODUCING A HANDLEBAR ARRANGEMENT

(71) Applicant: Weber Fibertech GmbH, Markdorf (DE)

(72) Inventors: Bilal AHMAD, Immenstaad (DE); Norbert STÖTZNER, Markdorf (DE); Björn SONNENSTÄDT, Markdorf (DE)

(21) Appl. No.: 18/389,936

(22) Filed: Dec. 20, 2023

(30) Foreign Application Priority Data
Dec. 20, 2022 (DE) 20 2022 107 086.5

(51) Int. Cl. B62K 21/12

(52) U.S. Cl. CPC B62K 21/12

(57) ABSTRACT

A method of producing a handlebar arrangement, wherein the handlebar arrangement (10) has a handlebar (12) and a stem (14), and the handlebar (12) and the stem (14) are produced in one part by means of a fluid injection technique.

The present invention relates to a method for producing a handlebar arrangement and to such a handlebar arrangement comprising a handlebar and a stem.

The handlebar arrangement presented is used for two-wheelers, e.g. bicycles, cargo bikes, so-called e-bikes and similar vehicles. However, applications in other vehicles, such as quad bikes, watercraft, snowmobiles, etc., are also conceivable. The handlebar arrangement comprises a handlebar, which serves as a handlebar handle for the rider, and a stem. The handlebar is part of the two-wheeler and is connected to the fork shaft via the stem. The fork shaft, in turn, is guided in a control tube and merges into a fork in which the articulated wheel is held. This allows the rider to control the two-wheeler.

It is known to form the two components of the handlebar arrangement, the handlebar and the stem, as separate or distinct metallic components. This means that the metal handlebar and stem have to be manufactured separately and then joined together, resulting in increased costs and weight.

As an alternative, consideration was given to producing the two components by means of injection molding with unreinforced or reinforced plastic materials. However, it has been shown that it is not possible to achieve a sufficiently stable or strong structure in this manner that is suitable for bearing the applied or incident loads or stresses.

The publication DE 298 13 642 A1 describes a bicycle frame which has a main frame, a front fork and a handlebar. These components are manufactured by plastic injection. The publication describes a handlebar which is designed in one piece with a handlebar tube corresponding to a fork shaft.

The publication DE 20 2021 104 254 A1 describes a handlebar arrangement with a handlebar and a support. A cover can be glued to an outer circumferential surface of the handlebar, but this only serves as a cover and does not provide any structural support.

The publication U.S. Pat. No. 6,588,297 B1 discloses an integrated handlebar arrangement or a driving control arrangement that can be coupled to a handlebar-steered vehicle. The publication describes a support structure, which is part of the handlebar, in which a reinforcement can be provided.

Against this background, a method in accordance with claim 1 and a handlebar arrangement with the features of claim 7 are presented. Embodiments are shown in the dependent claims, in the description and in the drawing.

The method described is used for the production of a handlebar arrangement which can be provided for a vehicle, such as a two-wheeler, a quad bike, a watercraft, a snowmobile, etc. The method involves producing a handlebar and a stem in one part by means of a fluid injection technique. The handlebar and stem then form the handlebar arrangement. The handlebar typically has a hollow profile, at least in portions.

The handlebar arrangement presented can be produced in one step by means of the fluid injection technique. This can then be connected to a fork shaft via the stem. This fork shaft is not part of the handlebar arrangement. Only the handlebar and stem form a one-piece unit, referred to herein as the handlebar arrangement.

In embodiments, the fluid injection technique is combined with an extrusion method, an injection molding method or another suitable method.

The fluid injection technique used can be selected from a group consisting of: water injection technology, gas injection technology and projectile injection technology.

A ribbed structure can be incorporated into the stem during production. This can be done in the handlebar and stem production step described above or in a separate step. This ribbed structure serves to reinforce the totality of the construction and increases the stability and resistance of the manufactured handlebar arrangement.

In addition, a cover can be inserted into the stem, which in turn is connected to the stem by means of a technique selected from a group consisting of: thermal welding, gluing, mechanical connection, e.g. by means of bolts.

The inserted cover can serve both as a cover and as an additional structural element that contributes to the stability of the totality of the construction. The cover is designed accordingly for this purpose. This is typically done using CAE tools, such as FEM simulation (FEM: finite element method) so that when it is connected to the ribs of the stem, the stem bears the force acting on the handlebar.

Fluid injection technology (FIT) is an umbrella term for methods in which hollow spaces are created by injecting a fluid. Fluid injection technology can be combined with injection molding, extrusion methods or any other suitable method. FIT is used in particular in connection with plastics, particularly fiber-reinforced plastics. In addition to the usual design features of plastic parts, this technique or process can be used to produce hollow profiles in the components, wherein this can be done at low cost. Due to the hollow geometry of the components, FIT components have a higher rigidity, while at the same time being lightweight and cost-efficient to produce.

Fluid injection technology has a number of advantages over conventional injection molding processes, particularly in some of the designs presented herein:
significant reduction in cycle time,
better stiffness/weight ratio,
reduction in the use of materials,
uniform shrinkage, less warpage,
reduction of sink marks,
reduction of binding seams,
reduction of the clamping force on the injection molding machine,
realization of longer flow paths,
increased design possibilities for the components.

The handlebar arrangement presented is intended, for example, for a two-wheeled vehicle, such as a bicycle or an e-bike. The handlebar arrangement has a handlebar and a stem, wherein the handlebar and the stem are produced in one part, i.e. in one piece, by means of a fluid injection technique. The handlebar has a hollow profile at least in portions, i.e. it is hollow at least in portions, e.g. shaped like a tube.

The handlebar arrangement presented can also be used in other vehicles, such as quad bikes, watercraft and snowmobiles.

The stem connects the handlebars to the fork shaft, which in turn is guided in a control tube. The steering movement of the rider, which is initiated via the handlebars, is transmitted in this way to the articulated wheel, typically the front wheel.

It can be seen that a sufficiently stable construction can be achieved by means of production of the handlebar and stem using a fluid injection technique from a plastic material, e.g. a carbon fiber or glass fiber reinforced thermoplastic material, to obtain a part or component.

In this manner, the number of components can also be reduced. Weight can also be reduced while achieving the required structural integrity, i.e. rigidity and strength.

The additional attachment of a cover, as shown in FIG. 1, for example, can bring further advantages in terms of rigidity and strength.

The redesigned handlebar arrangement also offers space to accommodate electronic apparatus in the stem. Furthermore, brake cables and hoses, for example, can be routed inside and outside the hollow profile of the handlebar.

The handlebar and the stem are designed or produced as one part or component, see FIG. 3, wherein this can be produced using a fluid injection technique. A water injection technique, a gas injection technique or a projectile injection technique can be used.

The inner profile of the hollow handlebar is round or elliptical, for example. However, other internal profiles are also possible. With the water injection technique, the shape of the hollow profile depends on the outer shape of the cross-section. With the projectile injection technique, the hollow profile takes the shape of the projectile.

A ribbed structure can be provided on or in the stem. This is molded on, for example, so that the totality of the component can be produced in one step. To make the stem even more stable or stronger, a cover, see FIG. 2, can be provided, which is attached to the ribs or rib structure. The cover can, for example, be attached or fastened by means of heating element welding or gluing. This cost-effective lightweight construction is layered to accommodate all possible loads that can occur on the handlebar and handlebar arrangement. This has been confirmed by tests.

The stem can of course also be designed without ribs. In this case, the cover can be attached to an open perimeter or boundary of the stem so that a closed profile is achieved. This results in sufficient mechanical stability, while the inside of the stem is closed or limited.

The integrated handlebar arrangement with handlebar and stem can be used without a cover, as represented in FIG. 3. The design of the ribs can be configured for functional integration. This also reduces the number of components at the expense of reducing the strength of the overall structure. One cost-efficient strategy, for example, is to produce handlebars and stems with ribs, see FIG. 3, and test them. If the test is passed, no cover is required. If the test is not passed, the cover must be produced and joined to increase the strength.

The stem can be freely designed, including functional integration of features such as a hole for screws in ribs or covers, clips or clamps for a removable protective cover.

The proposed design provides sufficient space within the stem to accommodate electronic apparatus. The electronic apparatus can be protected by attaching a removable protective cover to the open side of the stem, for example.

Brake cables and control cables for electronic apparatus can be routed through the inside of the handlebar's hollow profile. It is possible to route the cables on the exterior side, for example by using channels, e.g. in the form of grooves.

It is understood that the features mentioned above and those to be explained below can be used not only in the combination indicated in each case, but also in other combinations or on their own, without going beyond the scope of the present invention.

Further advantages and embodiments of the invention are shown in the description and the accompanying drawing.

### BRIEF DESCRIPTION OF THE DRAWING

FIG. 1 shows a perspective representation of an embodiment of the handlebar arrangement presented.

FIG. 2 shows the cover from FIG. 1.

FIG. 3 shows the handlebar arrangement from FIG. 1 without cover.

FIG. 4 shows a sectional view of the handlebar arrangement from FIG. 3.

FIG. 5 shows another embodiment of the handlebar arrangement in a view from below.

FIG. 6 shows a possible sequence of the method presented using several illustrations.

### EMBODIMENTS OF THE INVENTION

The invention is shown schematically by means of embodiments in the drawing and is described in detail below with reference to the drawing.

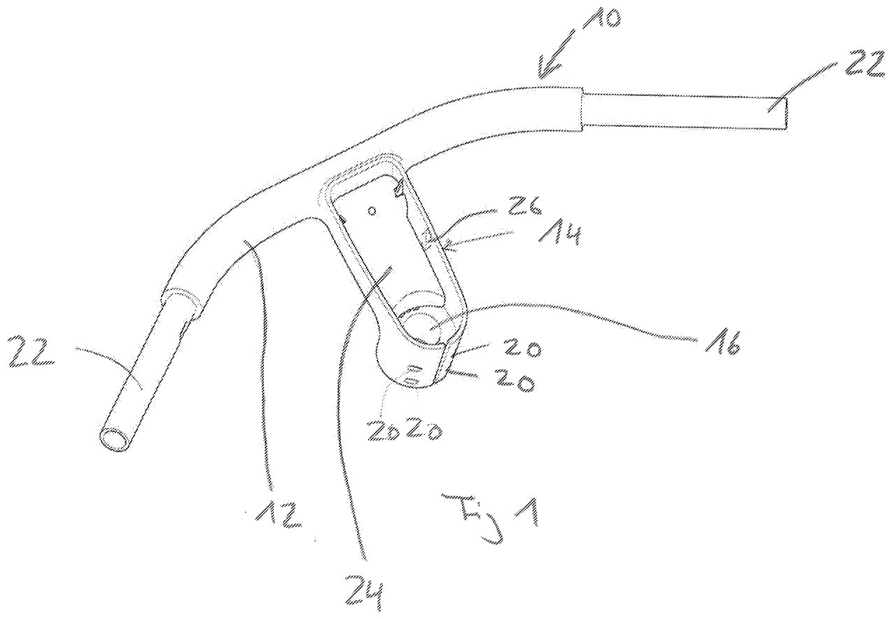

FIG. 1 shows an embodiment of the handlebar arrangement, which is designated overall by the reference number 10. The representation shows a handlebar 12 and a stem 14, which are produced together as one part by means of a fluid injection technique. This ensures a stable structure of the overall arrangement. The stem 14 connects the handlebar 12 to a fork shaft 16, which is not represented here. The opening 16 or hole 16, in which the fork shaft is mounted, can be seen.

It is significant that the handlebar 12 and the stem 14 form a unit, which is referred to here as handlebar arrangement 10. This handlebar arrangement 10 is to be connected to a fork shaft (not shown here), which is not part of the handlebar arrangement 10. The fork shaft is thus a separate component from the handlebar arrangement 10 and is not designed as a single part or in one piece with this handlebar arrangement.

The handlebar 12 is hollow, at least in sections, so that brake cables and control cables, for example, can be routed through it. Furthermore, the handlebar 12 is curved, and handles 22 are provided at opposite ends of the handlebar 12. However, handlebars shaped in other ways and straight handlebars are also conceivable. A steering movement of the handlebar 12, initiated in the area of the hand grips 22, is transmitted to the articulated wheel via the stem 14 and the fork shaft.

The stem 14 is constructed in the manner of a shell with one open side; a cover 24 is inserted into this area, which covers a room, which cannot be seen here, in the stem and yet still leaves space 26 available above the cover 24 in the stem to accommodate, for example, technical apparatus, such as measuring apparatus or display devices. These can then be covered with a protective cover.

In the case of this cover 24, it should be noted that it not only serves as a cover, but can also be designed as a structural component and can provide structural support for the totality of the structure. The cover 24 is therefore also referred to as a structured cover.

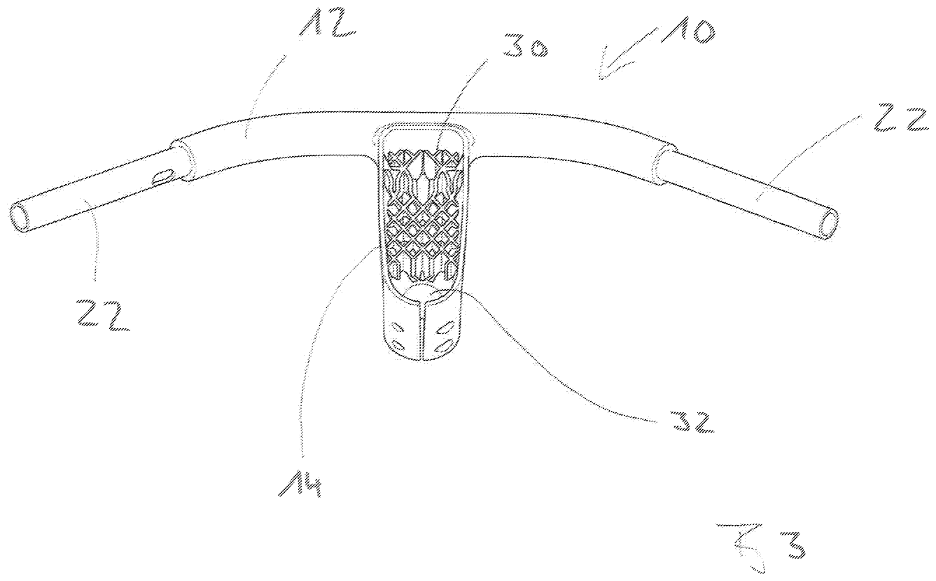

The cover 24 can be injection molded from the same material as the handlebar arrangement 10, allowing thermal welding. Another way to connect or weld the cover 24 or structural cover to the stem ribs (reference number 30 in FIG. 3) is to use the thermoformed fiber-reinforced composite material with the same matrix material as the handlebar arrangement 10. It is possible to use other materials for the structural cover if other joining methods, such as adhesives or fastening elements, are used. When the handlebar arrangement 10 is loaded, the cover 24 forms a closed profile for load absorption. This is particularly important together with the rib structure for the structural strength, e.g. under torsional load, when the handle 22 of the handlebar 12 is pushed downwards or pulled upwards from one side.

The four holes 20 are intended for a clamp connection with two screws. However, alternative connection options can also be used here.

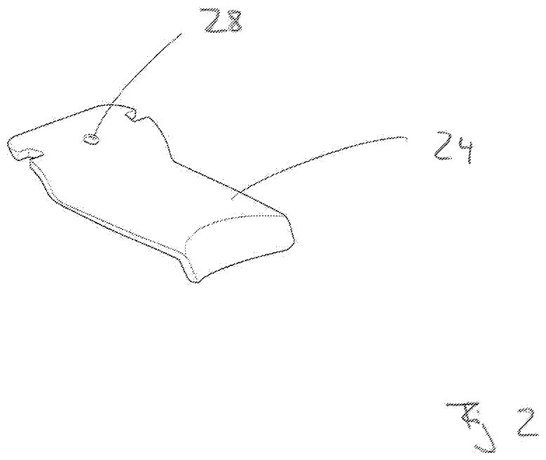

FIG. 2 shows a perspective representation of the cover 24, which can also be designed as a plastic injection-molded component. The cover 24 is adapted to the stem 14 of FIG. 1 or its shell-like structure, so that the cover 24 closes off an area in the stem 14 as tightly as possible. In this manner, apparatus in the stem 14 under the cover 24 can be protected from environmental influences. Furthermore, a screw attachment 28 is provided in the cover 24, which makes it possible to screw electronic apparatus to the cover 24. This design can be modified in accordance with the mounting requirements of the electronic apparatus.

FIG. 3 shows the handlebar arrangement 10 with the handlebar 12 and the stem 14, but without the cover. A ribbed structure 30 can be seen in the stem 14, which consists of a plurality of ribs and which increases the mechanical stability of the stem 14 and thus of the overall arrangement. This ribbed structure 30 can be injection-molded during the manufacturing process of the handlebar arrangement 10 or can be added or molded on later.

In the representation shown, the ribs are pointing upwards. This direction can also be reversed so that the upper side has a flat surface.

In this embodiment, the rib structure 30 or the design of the rib structure 30 extends in a diagonal direction. The rib design can be changed depending on the mechanical requirements.

The representation also shows a hole 32 through which the fork shaft is to be performed.

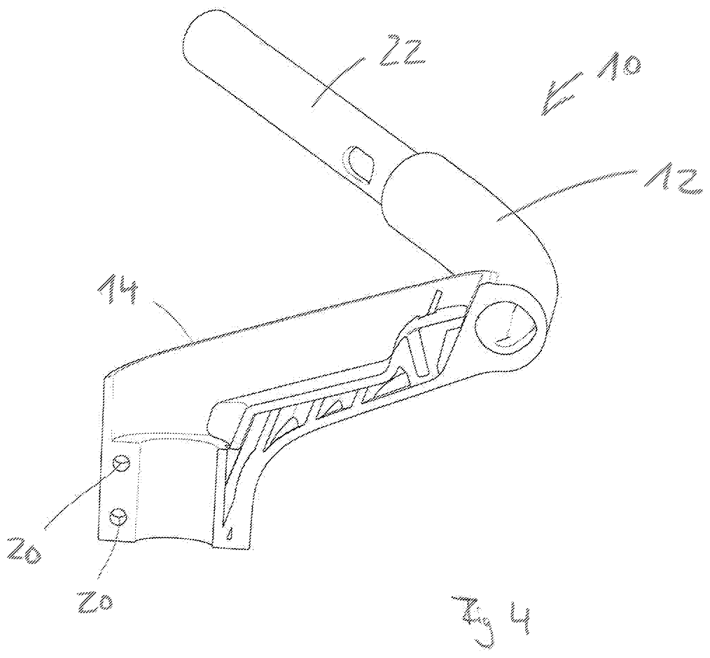

FIG. 4 shows a section through a portion of the handlebar arrangement 10 as shown in FIG. 3. The representation shows the left side of the handlebar 12 with the stem 14, which is shown cut here. The ribbed structure 30 is clearly recognizable. The hollow profile of the handlebar 12 is also visible. This is not completely circular, as the wall thickness of the hollow cross-section depends on the outer cross-section.

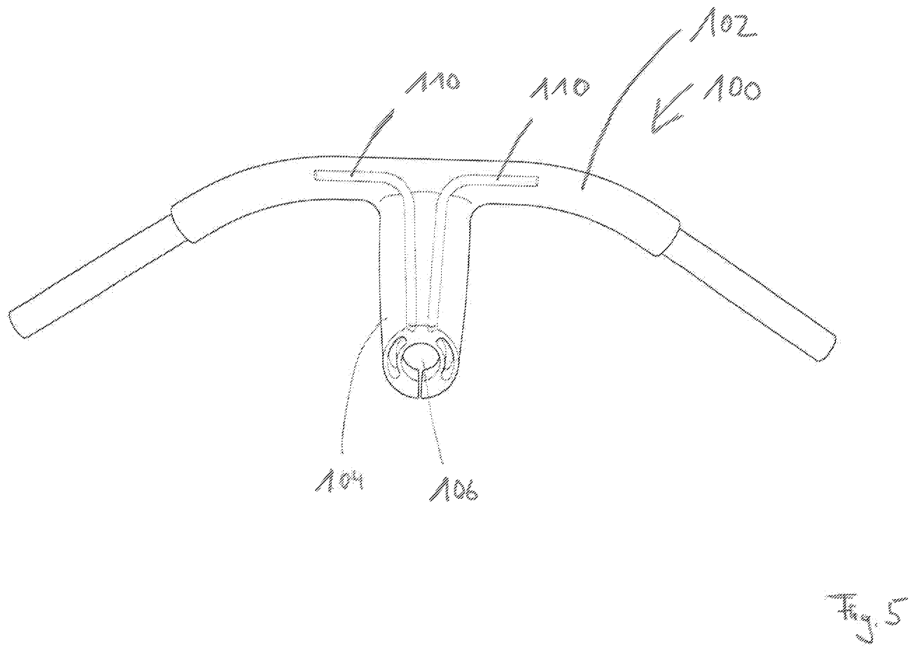

FIG. 5 shows a bottom view of a handlebar arrangement 100 with a handlebar 102 and a stem 104. You can also see the hole 106 for the fork shaft. Two channels 110 extend in the handlebar 102 for the receptacle of, for example, conduits, cables, cable pulls, control cables, hoses or other elements to be guided.

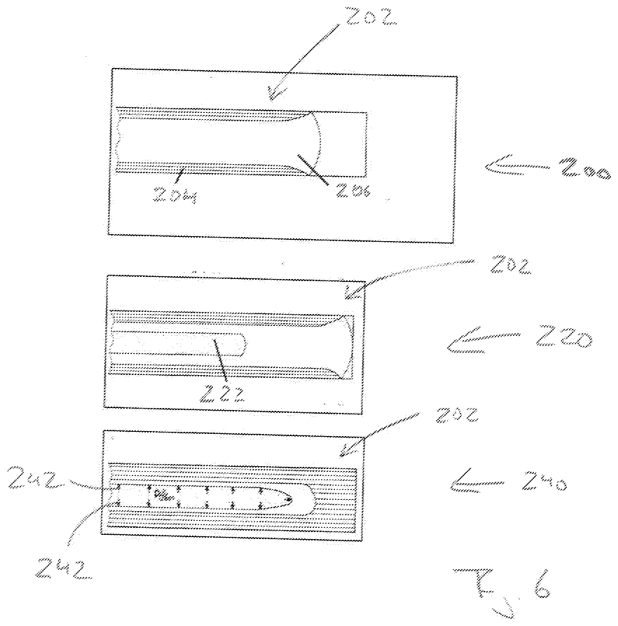

FIG. 6 shows three illustrations of a possible method sequence based on fluid injection technology (FIT). In a first step, the polymer melt is injected into a cavity. FIG. 6 above (reference number 200) shows a hollow space 202 in the tool after injection of the polymer melt. Reference number 204 denotes a frozen edge layer. Reference number 206 denotes a liquid core.

The shape of the hollow space 202 corresponds to that of the outer shape of the hollow profile part. When the molten polymer melt is injected, here from left to right, the molten polymer that comes into contact with the mold walls initially begins to cool down. It can therefore be seen that only the edge layer is frozen, but the center is in molten form.

In the next step, the liquid is injected into the liquid core of the polymer. FIG. 6 shows in the center (reference number 220) the hollow space 202 during fluid injection. Reference number 222 denotes injected fluid.

The fluid is injected at 220. The fluid is injected in such a manner that the molten material is pressed out in the middle and the desired hollow channel is created. Subsequently, at 240, the fluid injection phase is switched to the holding pressure phase, in which pressure is built up in the channel to press the plastic against the mold walls. The plastic is also cooled from the inside of the hollow channel.

FIG. 6 shows below (reference number 240) the hollow space 202 during the pressurization phase of the fluid. Arrows 242 illustrate the gas pressure. A fluid can be used instead of a gas.

In a subsequent step, the fluid is removed from the hollow space. The finished component is then obtained.

Factors influencing the component properties are
1. FIT process
   a. gas injection technology (GIT), water injection technology (WIT) or projectile injection technology (PIT)
   b. process variant
2. Machine parameters
   a. fluid volume flow
   b. delay time
   c. fluid holding time
   d. melting temperature
3. Geometry
   a. design of the component
   b. design of the hollow space
   c. design of the tool
   d. injection point for the fluid
4. Material properties
   a. structure (amorphous/semi-crystalline)
   b. filler and proportion
   c. viscosity
   d. moisture content

Selection criterion and advantages/disadvantages of FIT process (GIS, FIT, PIT)

### GIS:

with shrinkage compensation,
no possibility of injector connection to the component,
no possibility to remove the injected water.

### WIT

for components where the water can be drained,
for components where the water can be removed again,
for components with long channels,
for components with large diameters.

The advantages of using water over gas are:
water has a much higher cooling effect than gas, which leads to a reduction in cooling time,
water is almost incompressible, which leads to better process control,
water is available almost everywhere and is much cheaper than nitrogen,
water is not compressible, so the water injection speed can be controlled separately from the water pressure, i.e. the same technology as on the injection unit of the SGM (injection molding machine),
water enters the side surfaces much later than gas,
water has 40 times the heat capacity of gas,
components are cooled from the inside and outside,
drastically shorter cooling times are possible,
larger diameters can be blown out,
there are no fluid costs,
compared to gas, the reproducibility is better.

### PIT

homogeneous internal diameter,
ideal for tubes, no undefined bottle necks,
projectile placed on injector,
projectile pressed through the fluid through the filled hollow space.

Advantages and disadvantages of PIT compared to conventional FIT
Advantages include:
the residual wall thickness of the components can be adjusted and is largely independent of the rheological properties,
   material savings due to wall thickness reduction,
   reduction of the cycle time.
FIT design restrictions can be overcome,
no direct contact of the fluid with the polymer melt.

Disadvantages include:
only identical cavity cross-sections can be realized,
additional effort is required for the production and handling of the projectile.

1-10. (canceled)

11. A method of producing a handlebar arrangement comprising a handlebar and a stem, the method comprises the step of producing the handlebar and the stem as one part by means of a fluid injection technique.

12. The method according to claim 11, wherein the fluid injection technique is combined with an extrusion method or an injection molding method.

13. The method according to claim 11, wherein the fluid injection technique is selected from a group consisting of water injection technology, gas injection technology and projectile injection technology.

14. The method according to claim 11, wherein the stem is provided with a ribbed structure.

15. The method according to claim 11, wherein a cover is additionally inserted into the stem.

16. The method according to claim 15, wherein the cover is connected to the by means of a technique selected from a group consisting of: thermal welding, adhesive bonding, mechanical connection by means of bolts.

17. A handlebar arrangement, comprising:
a handlebar and a stem;
the handlebar and the stem are produced as one part by means of a fluid injection technique, and
the handlebar has a hollow profile at least in portions.

18. The handlebar arrangement according to claim 17, wherein a ribbed structure is provided in the stem.

19. The handlebar arrangement according to claim 17, wherein a cover is inserted into the stem.

20. The handlebar arrangement according to claim 17, wherein the stem has apparatus for removably attaching a protective cover.
